(19) United States
(12) Patent Application Publication
(10) Pub. No.: US 2009/0290985 A1
(43) Pub. Date: Nov. 26, 2009

(54) PROCESS FOR CONNECTING METALLIC STRUCTURAL ELEMENTS AND COMPONENTS PRODUCED THEREBY

(75) Inventors: Herbert Hanrieder, Hohenkammer (DE); Alexander Gindorf, Schwabhausen (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/293,543

(22) PCT Filed: Mar. 14, 2007
(86) PCT No.: PCT/DE07/00453

§ 371 Date: Sep. 18, 2008

(30) Foreign Application Priority Data
Mar. 20, 2006 (DE) 10 2006 012 662.9

(51) Int. Cl. F01D 5/30; B23K 13/01

(52) U.S. Cl. 416/213 R; 219/617

(57) ABSTRACT

A process for connecting metallic structural elements, in particular structural elements of a gas turbine, and a component made by the process, is disclosed. The connecting of corresponding connecting surfaces of the structural elements is performed by inductive high-frequency pressure welding and the structural elements consist of different or similar metallic materials with different permeabilities and/or thermal conductivities. During the inductive high-frequency pressure welding, at least one process-specific parameter is controlled in such a way that at least the connecting surfaces are respectively heated essentially simultaneously up to at least near the respective melting point of the metallic materials.

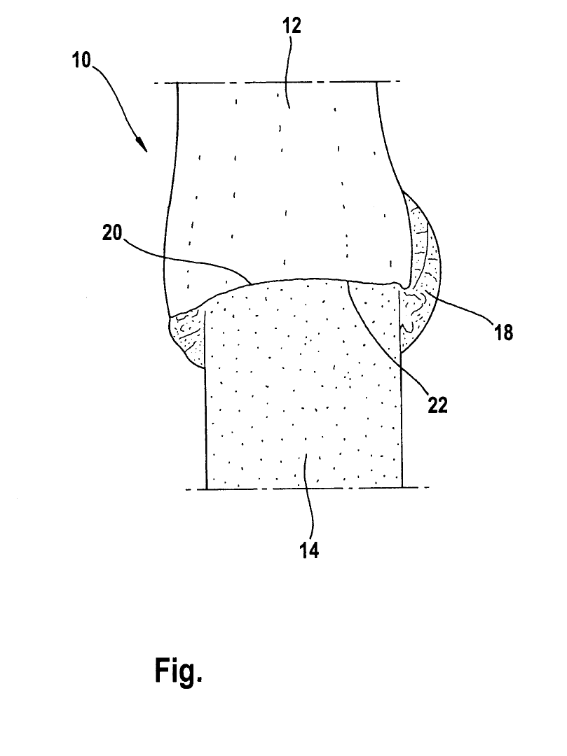

This application claims the priority of International Application No. PCTDE2007000453, filed Mar. 14, 2007, and German Patent Document No. 10 2006 012 662.9, filed Mar. 20, 2006, the disclosures of which are expressly incorporated by reference herein.

### BACKGROUND AND SUMMARY OF THE INVENTION

The present invention relates to a method for connecting metallic structural elements, in particular structural elements of a gas turbine, wherein the connecting of corresponding connecting surfaces of the structural elements is performed by means of inductive high-frequency pressure welding. The invention also relates to a component manufactured by means of the process.

Various processes for connecting metallic structural elements by means of inductive high-frequency pressure welding are known from the prior art. Thus, German Patent Document No. DE 198 58 702 A1 describes a process for connecting blade parts of a gas turbine, wherein a blade pan section and at least one other blade part are made available. In this case, corresponding connecting surfaces of these elements are essentially positioned, aligned and spaced apart from one another and then welded to one another by exciting an inductor with high-frequency current and by moving them together with their connecting surfaces making contact. In this process, the inductor is excited with a constant frequency, which generally lies above 0.75 MHz. In addition, the frequency is selected as a function of the geometry of the connecting surfaces. In the case of inductive high-frequency pressure welding, heating the two welding mates is of crucial importance for the quality of the joint. What is disadvantageous in the known processes, however, is that only structural elements made of identical or similar materials that have identical or similar permeabilities, thermal conductivities or similar melting points can be welded together in this case.

As a result, it is the objective of the present invention to make available a generic process for connecting metallic structural elements, which guarantees a secure and lasting connection of structural elements made of different or similar metallic materials with different melting points, permeabilities and/or thermal conductivities.

Moreover, it is the objective of the present invention to make available a generic component, in particular a component of a gas turbine, which guarantees a secure and lasting connection between the individual structural elements.

For clarification purposes, it is expressly mentioned at this point that the designation inductive high-frequency pressure welding does not define the process or the component in the case at hand at a specific frequency range. In fact frequencies in the low kHz range up to the high MHz range are used so that the new designation inductive pressure welding (IPW) could also be adopted.

An inventive process for connecting metallic structural elements, in particular structural elements of a gas turbine uses inductive high-frequency pressure welding to connect corresponding connecting surfaces of the structural elements. In this case, the structural elements consist of different or similar metallic materials with different melting points, permeabilities and/or thermal conductivities. During the process of the inductive high-frequency pressure welding at least one process-specific parameter is controlled in such a way that at least the connecting surfaces are respectively heated essentially simultaneously up to at least near the respective melting point of the metallic materials. Because of the control possibilities in the case of the inventive process, the to-be-welded structural elements respectively form essentially simultaneously a molten layer on the connecting surfaces, which are then welded to one another by simple compression. In this case, it is possible for a connecting surface of the first structural element to be molten and the connecting surface of the second structural element to remain below the melting temperature.

However, it is also possible for both to remain just under the respective melting temperature or even for both to be heated to a temperature above the melting point of the respective material. What is vital for a secure and lasting connection between the individual structural elements is a connection zone that is free from defects after pressing out the melt and the corresponding material pairing. Because of the complete squeezing out of the melt from a joining area of the two structural elements, the so-called joint cross section is hot forged and therefore solid and resilient. Another advantage of the inventive process is that only low forces have to be applied for the welding or joining process. The inventive process also allows material combinations to be connected that due to their different properties could not be connected by known fusion welding processes, by rotary friction welding or even by the previously known inductive high-frequency pressure welding.

In an advantageous embodiment of the process, controlling at least one process parameter during the process of the inductive high-frequency pressure welding is comprised of varying the frequency induced by at least one inductor. The different levels of the frequencies, which normally lie between 7 kHz and 2.5 MHz, guarantee that the materials are formable superplastically and therefore can be connected to one another. In this case, the frequencies are selected in particular also as a function of the geometry of the connecting surfaces. In addition, it is possible for the induction to take place by means of an inductor, which induces at different strengths. However, it is also possible for two or more inductors to be used. In addition, it is conceivable for the connecting surfaces of the structural elements to be exposed to the different frequencies for different lengths of time.

In another advantageous embodiment of the invention process, controlling at least one process parameter during the process of the inductive high-frequency pressure welding is comprised of varying the position of the structural elements relative to the inductor or to the inductors. However, it is also possible for controlling at least one process parameter during the process of the inductive high-frequency pressure welding to be comprised of varying the distance of the respective structural elements relative to the inductor. Thus, for example, a displacement of the inductor in the direction of the structural element consisting of the metallic material with the higher melting temperature can take place.

In further advantageous embodiments of the inventive process, the first structural element is made of steel and the second structural element of a TiAl alloy. However, it is also possible for the first and second structural elements to be made of similar metallic materials and manufactured by different manufacturing processes. This relates for example to forged structural elements, structural elements produced by casting methods, structural elements comprised of single crystals as well as directionally solidified structural elements.

An inventive component, in particular a component of a gas turbine, is comprised of a first structural element and a second structural element, wherein the first and the second structural elements consist of different or similar metallic materials with different permeabilities and/or thermal conductivities. In this case, the structural elements are joined together by means of inductive high-frequency pressure welding. According to the invention, during the process of inductive high-frequency pressure welding at least one process-specific parameter is controlled in such a way that at least the connecting surfaces or joint surfaces of the structural elements are respectively heated essentially simultaneously up to at least near the respective melting point of the metallic materials. As a result, it is possible to manufacture a component, in which secure and lasting connections of the individual structural elements to one another are guaranteed. A connecting zone that is free from defects emerges after pressing out the melt and the diffusion of the different material pairing.

In an advantageous embodiment of the inventive component, the first structural element can be made of steel and the second structural element of a titanium aluminum alloy. However, it is also possible for the first and the second structural elements to be made of similar metallic materials and manufactured by different manufacturing processes.

In a further advantageous embodiment of the invention, the first structural element is a blade of a rotor in a gas turbine and the second structural element is a ring or a disk of the rotor. These components are so-called BLINGs (bladed ring) or BLISKs (bladed disk) of gas turbine engines.

Additional advantages, features and details of the invention are disclosed in the following description of a graphically depicted exemplary embodiment.

### BRIEF DESCRIPTION OF THE DRAWING

The FIGURE shows a section through a component 10 that is connected and manufactured in accordance with the invention.

### DETAILED DESCRIPTION OF THE DRAWING

In this case, the component 10 is comprised of a first structural element 12 and a second structural element 14, which were welded to one another by means of inductive high-frequency pressure welding. During the process of inductive high-frequency pressure welding at least one process-specific parameter was controlled in such a way that at least the connecting surfaces 20, 22 of the structural elements 12, 14 were respectively heated essentially simultaneously up to at least near the respective melting point of the metallic materials. In the depicted exemplary embodiment, the first structural element 12 is made of steel and the second structural element of a titanium aluminum alloy. To connect the first and second structural elements 12, 14, they were positioned essentially aligned and spaced apart from one another. They were welded to one another by exciting an inductor (not shown) with high-frequency current and by moving them together with the connecting surfaces 20, 22 making contact. The essentially simultaneous heating of the connecting surfaces 20, 22 respectively up to at least near the respective melting point of the metallic materials took place at a frequency of approximately 1.0 MHz. The coupling distance, i.e., the relative distance between the inductor and the structural elements 12, 14, was 1.5 mm. In order to achieve the essentially simultaneous melting of the materials of steel and the titanium aluminum alloy, the inductor was displaced in the direction of the higher melting material, namely the titanium aluminum alloy. The displacement in this case was 2 mm. Finally, the first and the second structural elements 12, 14 were connected to one another with a force of 250 N via a compression path of 1 mm and a welding time of 1.5 s.

In addition, one can see in the figure that an interdiffusion zone emerges between the joint surfaces 20, 22 of the first and second structural elements 12, 14, which, however, does not produce a material connection of the materials that are not miscible per se. Accumulations of material 18 arise on the edges of the connecting surfaces 20, 22, which arise from the titanium aluminum alloy material that is pressed out during joining.

1-14. (canceled)

15. A process for connecting metallic structural elements of a gas turbine, wherein the connecting of corresponding connecting surfaces of the structural elements is performed by inductive high-frequency pressure welding and the structural elements consist of different or similar metallic materials with different permeabilities and/or thermal conductivities, and wherein during the inductive high-frequency pressure welding at least one process-specific parameter is controlled in such a way that at least the connecting surfaces are respectively heated essentially simultaneously up to at least near a respective melting point of the metallic materials.

16. The process according to claim 15, wherein the controlling the at least one process-specific parameter is comprised of varying a frequency induced by at least one inductor.

17. The process according to claim 16, wherein the frequency is selected as a function of a condition and a geometry of the connecting surfaces.

18. The process according to claim 16, wherein the at least one inductor is excited with a frequency between 7 kHz and 2.5 MHz.

19. The process according to claim 15, wherein the controlling the at least one process-specific parameter is comprised of varying a position of the structural elements relative to an inductor.

20. The process according to claim 15, wherein the controlling the at least one process-specific parameter is comprised of varying a distance of the structural elements relative to an inductor.

21. The process according to claim 19, wherein a displacement of the inductor in a direction of the structural element consisting of a metallic material with a higher melting temperature takes place.

22. The process according to claim 20, wherein a displacement of the inductor in a direction of the structural element consisting of a metallic material with a higher melting temperature takes place.

23. The process according to claim 15, wherein one of the structural elements is made of steel and an other of the structural elements is made of a TiAl alloy.

24. The process according to claim 15, wherein the structural elements are made of similar metallic materials and manufactured by different manufacturing processes.

25. The process according to claim 15, wherein one of the structural element is a blade of a rotor in the gas turbine and an other of the structural elements is a ring or a disk of the rotor.

26. A component of a gas turbine, comprising a first structural element and a second structural element, wherein the first and the second structural elements consist of different or similar metallic materials with different permeabilities and/or thermal conductivities and are welded by inductive high-frequency pressure welding, wherein during the inductive high-frequency pressure welding, at least one process-specific parameter is controlled in such a way that at least connecting surfaces of the structural elements are respectively heated essentially simultaneously up to at least near a respective melting point of the metallic materials.

27. The component according to claim 26, wherein the first structural element is made of steel and the second structural element is made of a TiAl alloy.

28. The component according to claim 26, wherein the first structural element and the second structural element are made of similar metallic materials and manufactured by different manufacturing processes.

29. The component according to claim 26, wherein the first structural element is a blade of a rotor in the gas turbine and the second structural element is a ring or a disk of the rotor.

30. A process for connecting metallic structural elements of a gas turbine, comprising the steps of:
inductive high-frequency pressure welding of connecting surfaces of the structural elements, wherein the structural elements consist of different or similar metallic materials with different permeabilities and/or thermal conductivities; and
controlling at least one process-specific parameter during the inductive high-frequency pressure welding such that at least the connecting surfaces are respectively heated essentially simultaneously up to at least near a respective melting point of the metallic materials.

31. The process according to claim 30, wherein the step of controlling the at least one process-specific parameter is comprised of varying a frequency induced by at least one inductor.

32. The process according to claim 31, wherein the frequency is selected as a function of a condition and a geometry of the connecting surfaces.

33. The process according to claim 31, wherein the at least one inductor is excited with a frequency between 7 kHz and 2.5 MHz.

34. The process according to claim 30, wherein the step of controlling the at least one process-specific parameter is comprised of varying a displacement of an inductor in a direction of the structural element consisting of a metallic material with a higher melting temperature.
